(19) United States
(12) Patent Application Publication
(10) Pub. No.: US 2016/0054168 A1
(43) Pub. Date: Feb. 25, 2016

(54) APPARATUS FOR SENSING FUEL LEVEL

(71) Applicant: COAVIS, Sejong-si (KR)

(72) Inventors: Se Jin Kim, Sejong-si (KR); Suk Min Yun, Chungcheongbuk-do (KR); Sun Bok Baek, Daejeon (KR); In Seok Sohn, Chungcheongbuk-do (KR)

(21) Appl. No.: 14/833,338

(22) Filed: Aug. 24, 2015

(30) Foreign Application Priority Data
Aug. 25, 2014 (KR) 10-2014-0110701

(51) Int. Cl. G01F 23/296; B60K 15/03

(52) U.S. Cl. CPC G01F 23/296; B60K 15/03; B60K 2015/03217; B60K 2015/03236

(57) ABSTRACT

Provided is an apparatus for sensing a fuel level, and more particularly, an apparatus for sensing a fuel level that is installed in a fuel tank of a vehicle to sense the fuel level. The apparatus for sensing a fuel level may improve reliability of the sensing of the level because a pipe is vertically installed in the fuel tank and an ultrasonic wave sensor is provided to a lower end of an interior of the pipe to measure the level of the fuel by an ultrasonic wave, and a filter is installed in a fuel inflow and outflow hole formed in the pipe and prevents an inflow of foreign materials into the pipe, thereby making it possible to more accurately sense the level of the fuel.

### CROSS-REFERENCE TO RELATED APPLICATIONS

This application claims priority under 35 U.S.C. §119 to Korean Patent Application No. 10-2014-0110701, filed on Aug. 25, 2014, in the Korean Intellectual Property Office, the disclosure of which is incorporated herein by reference in its entirety.

### TECHNICAL FIELD

The following disclosure relates to an apparatus for sensing a fuel level, and more particularly, to an apparatus for sensing a fuel level that is installed in a fuel tank of a vehicle to sense the fuel level. The following disclosure relates to an apparatus for sensing a fuel level capable of improving reliability of the sensing of the fuel level because a fuel level may be accurately sensed by measuring the fuel level using an ultrasonic wave, preventing a fluid level of fuel to be measured from being shaken, and preventing foreign materials from being contained in the fuel to be measured.

### BACKGROUND

An apparatus of a vehicle such as a gasoline engine or a diesel engine that is driven by liquid fuel supplied thereto includes a fuel tank in which fuel is stored, a fuel pump module is installed in the fuel tank, and the fuel pump module is configured to be connected to an engine by a fuel supply line to supply the fuel stored in the fuel tank to the engine. In addition, the fuel pump module is mounted with an apparatus for sensing a fuel level so as to sense a level of the fuel filled in the fuel tank.

The apparatus for sensing the fuel level is generally configured so that a holder 30 connected to a float 10 by an arm 20 is rotated depending on a change in a height of the float 10 configured to float on a liquefied fuel surface, and the fuel level may be sensed according to a resistance value changed as a wiper coupled to the holder 30 is rotated while being in contact with a resistance substrate, as illustrated in FIG. 1.

In addition, as illustrated in FIG. 2, there is an apparatus for sensing a fuel level capable of the level of the fuel using an ultrasonic wave sensor installed in the fuel tank. The above-mentioned apparatus for sensing the fuel level is configured to sense the level of the fuel by transmitting an ultrasonic wave to the fuel surface using the ultrasonic sensor, receiving a reflected ultrasonic wave, and converting the reflected ultrasonic wave into a height.

However, in the apparatus for sensing the fuel level using the ultrasonic wave sensor described above, since the surface of the fuel filled in the fuel tank is not uniformly kept due to a shaking of the vehicle, a movement of the vehicle, the vehicle positioned on an inclined place, and the like, a diffused reflection of an ultrasonic wave may occur. As a result, a measurement value of the level may be varied.

### RELATED ART DOCUMENT

### Patent Document

(Patent Document 1) KR 10-2001-0083689 A (September 1, 2001)

### SUMMARY

An embodiment of the present invention is directed to providing an apparatus for sensing a fuel level that is installed in a fuel tank of a vehicle to sense the fuel level, and particularly, an apparatus for sensing a fuel level capable of improving reliability of the sensing of the fuel level because a fuel level may be accurately sensed by measuring the fuel level using an ultrasonic wave, preventing a fluid level of fuel to be measured from being shaken, and preventing foreign materials from being contained in the fuel to be measured.

In one general aspect, an apparatus for sensing a fuel level includes: a pipe 200 vertically installed in a fuel tank 100 and having an interior hollowed to have a fuel inflow and outflow hole 210 formed at a lower side thereof and a gas inflow and outflow hole 220 formed at an upper side thereof; and an ultrasonic wave sensor 300 provided to a lower end of the interior of the pipe 200 and measuring a level of the fuel by an ultrasonic wave.

The apparatus for sensing a fuel level may further include a filter 400 installed in the fuel inflow and outflow hole 210 of the pipe 200.

The filter 400 may be further installed in the gas inflow and outflow hole 220 of the pipe 200.

The ultrasonic wave sensor 300 may be provided to be spaced apart from an inner peripheral surface of the pipe 200 and the fuel inflow and outflow hole 210 may be installed at a lower end portion of the pipe 200.

The apparatus for sensing a fuel level may further include a buoyancy body 500 provided in the pipe 200 and floated by the fuel.

The buoyancy body 500 may be formed to have a length larger than a diameter.

The pipe 200 may be installed in the fuel tank 100 and the pipe 200 may be installed at a central portion of the fuel tank 100 in a horizontal direction of the fuel tank 100.

### BRIEF DESCRIPTION OF THE DRAWINGS

FIG. 1 is a perspective view illustrating an apparatus for sensing a fuel level of a contact type using a float according to the related art.

FIG. 2 is a schematic view illustrating an apparatus for sensing a fuel level using an ultrasonic wave sensor according to the related art.

FIGS. 3 to 5 are schematic cross-sectional views illustrating an apparatus for sensing a fuel level according to an exemplary embodiment of the present invention.

FIG. 6 is a schematic cross-sectional view illustrating an apparatus for sensing a fuel level including a buoyancy body according to an exemplary embodiment of the present invention.

FIGS. 7 and 8 are schematic views illustrating states sensing the level in a case in which the buoyancy body is present and in a case in which the buoyancy body is not present in a state in which a fuel tank according to the present invention is inclined.

FIG. 9 is a perspective view illustrating the buoyancy body according to an exemplary embodiment of the present invention.

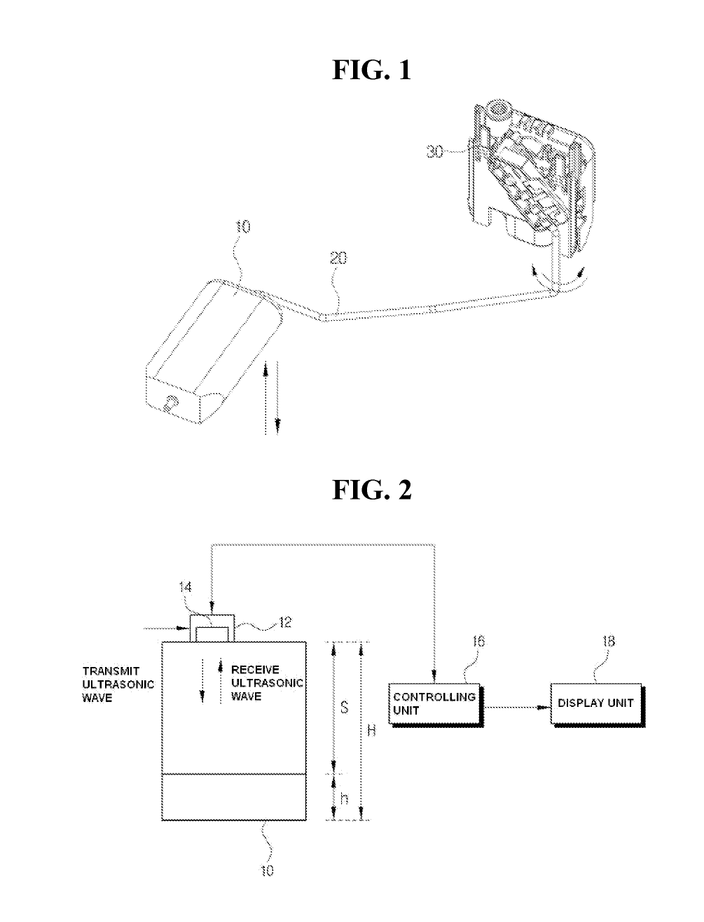

### DETAILED DESCRIPTION OF EMBODIMENTS

Hereinafter, an apparatus for sensing a fuel level according to an exemplary embodiment of the present invention as described above will be described in detail with reference to the accompanying drawings.

First, the present invention relates to an apparatus for sensing a fuel level. The apparatus for sensing the fuel level may be installed in a fuel tank of a vehicle to be used to measure a level of fuel and may be applied to various applications measuring a level (height) of fluid, in addition to that described above.

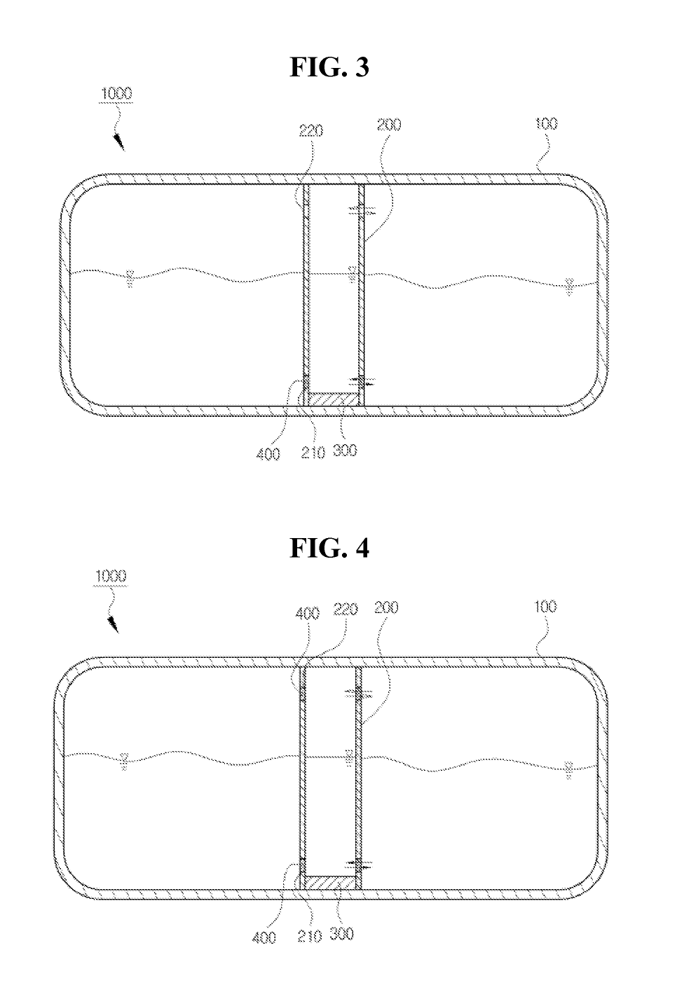

FIGS. 3 to 5 are schematic cross-sectional views illustrating an apparatus for sensing a fuel level according to an exemplary embodiment of the present invention.

As illustrated, an apparatus 1000 for sensing a fuel level according to the present invention may be configured to include a pipe 200 vertically installed in a fuel tank 100 and having an interior hollowed to have a fuel inflow and outflow hole 210 formed at a lower side thereof and a gas inflow and outflow hole 220 formed at an upper side thereof; and an ultrasonic wave sensor 300 provided to a lower end of the interior of the pipe 200 to be in contact with fuel and measuring a level of the fuel by an ultrasonic wave.

The fuel may be filled in the fuel tank 100.

In addition, the pipe 200 may be installed in the fuel tank 100 and the pipe 200 may be vertically installed. In this case, the interior of the pipe 200 is hollowed, such that an upper end of the pipe 200 may be fixed to an upper side of the fuel tank 100 and a lower end thereof may be fixed to a bottom of the fuel tank 100. In addition, the pipe 200 has the fuel inflow and outflow hole 210 formed in a lower side surface thereof, such that the fuel inflows and outflows through the fuel inflow and outflow hole 210 and an interior of the fuel tank 100 and the interior of the pipe 200 are in communication with each other, thereby making it possible to keep a surface of the fuel in the fuel tank 100 and a surface of the fuel in the pipe 200 at the same height. In addition, the pipe 200 has the gas inflow and outflow hole 220 formed in an upper side surface thereof, such that gas inflows and outflows through the gas inflow and outflow hole 220, and the interior of the pipe 200 and the interior of the fuel tank 100 are in communication with each other. Thereby, since pressure is not applied to the gas present in an upper side of the interior of the pipe 200, the fuel may smoothly flow through the fuel inflow and outflow hole 210, thereby making it possible to keep the surface of the fuel in the fuel tank 100 and the surface of the fuel in the pipe 200 at the same height.

The ultrasonic wave sensor 300 is provided to the lower end of the interior of the pipe 200 to measure the level of the fuel by the ultrasonic wave, and the ultrasonic wave sensor 300 may be fixed to an inner peripheral surface of the lower end of the pipe 200 or may be fixed to the bottom surface of the fuel tank 100. In this case, the fuel inflow and outflow hole 210 formed at the lower side of the pipe 200 so as to allow the fuel to smoothly flow into the interior and the exterior of the pipe 200 may be formed at an upper side of the ultrasonic wave sensor 300.

Thus, even though the surface of the fuel in the fuel tank is shaken due to a vibration, a shaking, a movement of the vehicle, and the like, the surface of the fuel in the pipe may be hardly shaken, thereby making it possible to accurately sense a height of the surface of the fuel using the ultrasonic wave sensor.

Thereby, in the apparatus for sensing the fuel level according to the exemplary embodiment of the present invention, since a fluid level of the fuel to be measured is not shaken, the level of the fuel may be accurately measured using the ultrasonic wave sensor.

In addition, the apparatus for sensing the fuel level according to the exemplary embodiment of the present invention may be configured to further include a filter 400 installed in the fuel inflow and outflow hole 210 of the pipe 200.

That is, in a case in which foreign materials are contained in the fuel, which is a medium through which the ultrasonic wave is transmitted (in a case in which the foreign materials are present on a path through which the ultrasonic wave is transmitted), since a diffused reflection of the ultrasonic wave may occur, the level may not be accurately sensed and the fuel filled in the fuel tank 100 may contain the foreign materials. Thus, since the foreign materials do not inflow into the pipe 200 by installing the filter 400 in the fuel inflow and outflow hole 210 as illustrated in FIG. 3, the fuel to be measured does not contain the foreign materials, thereby making it possible to more accurately sense the level of the fuel. In this case, the filter 400 may be preferably installed so as not to protrude from the inner peripheral surface of the pipe 200 so that interference of the ultrasonic wave does not occur.

In addition, the filter 400 may be further installed in the gas inflow and outflow hole 220 of the pipe 200.

Since the fuel may also inflow into the pipe 200 through the gas inflow and outflow hole 220 in a case in which a lot of fuel is filled in the fuel tank 100, the filter 400 may also be installed in the gas inflow and outflow hole 220 in order to prevent an inflow of the foreign materials through the gas inflow and outflow hole 220, as illustrated in FIG. 4. In this case, the filter 400 installed in the fuel inflow and outflow hole 210 and the filter 400 installed in the gas inflow and outflow hole 220 may be the same as each other or may be different from each other.

In addition, the ultrasonic wave sensor 300 may be provided to be spaced apart from the inner peripheral surface of the pipe 200 and the fuel inflow and outflow hole 210 may be installed at a lower end portion of the pipe 200.

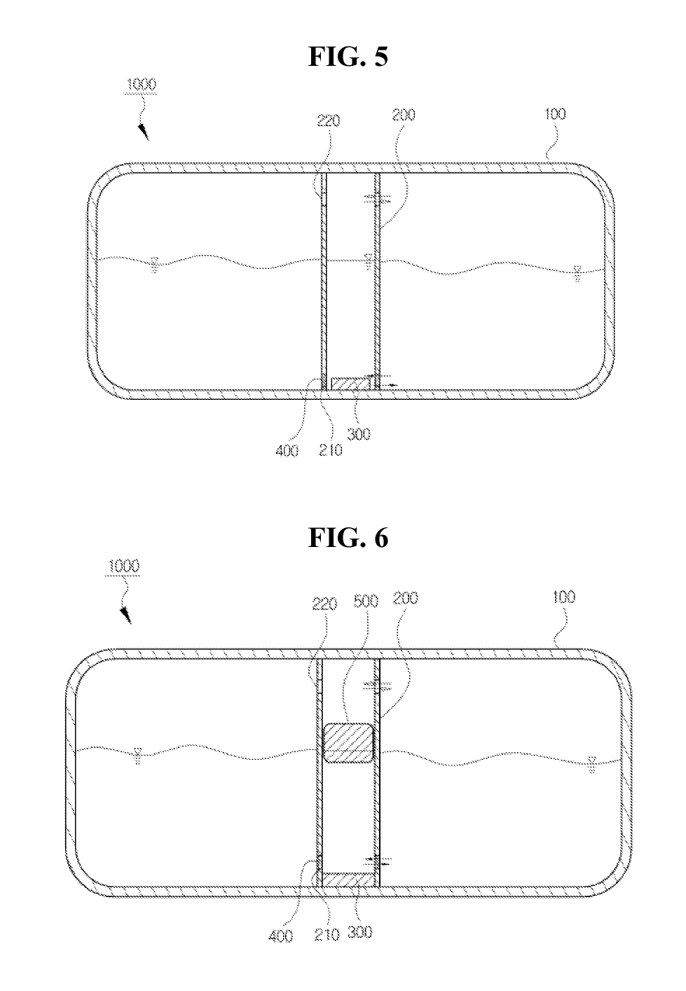

That is, the fuel inflow and outflow hole 210 may be formed to be close to the bottom surface of the fuel tank 100, which is the lower end portion of the pipe 200, as illustrated in FIG. 5 so that the fuel may smoothly flow in the fuel tank 100 and the pipe 200 even in a case in which the level of the fuel tank 100 is small, and the ultrasonic wave sensor 300 may be installed to be spaced apart from the inner peripheral surface of the pipe 200 so that the fuel may smoothly flow through the fuel inflow and outflow hole 210.

In addition, the apparatus for sensing the fuel level according to the exemplary embodiment of the present invention may be configured to further include a buoyancy body 500 provided in the pipe 200 and floated by the fuel.

As illustrated in FIG. 6, the buoyancy body 500 is provided in the pipe 200, such that the buoyancy body 500 may be vertically moved along the inner peripheral surface of the pipe 200. The buoyancy body 500 may float around the surface of the fuel due to buoyancy force and may be vertically moved in the pipe 200 depending on the height of the surface of the fuel.

Thereby, even in a case in which the surface of the fuel in the pipe is slightly shaken, the buoyancy body 500 may be hardly shaken and may keep a horizontal state, and the ultrasonic wave transmitted from the ultrasonic wave sensor 300 may be reflected from a lower surface of the buoyancy body 500, thereby making it possible to more accurately measure the level of the fuel.

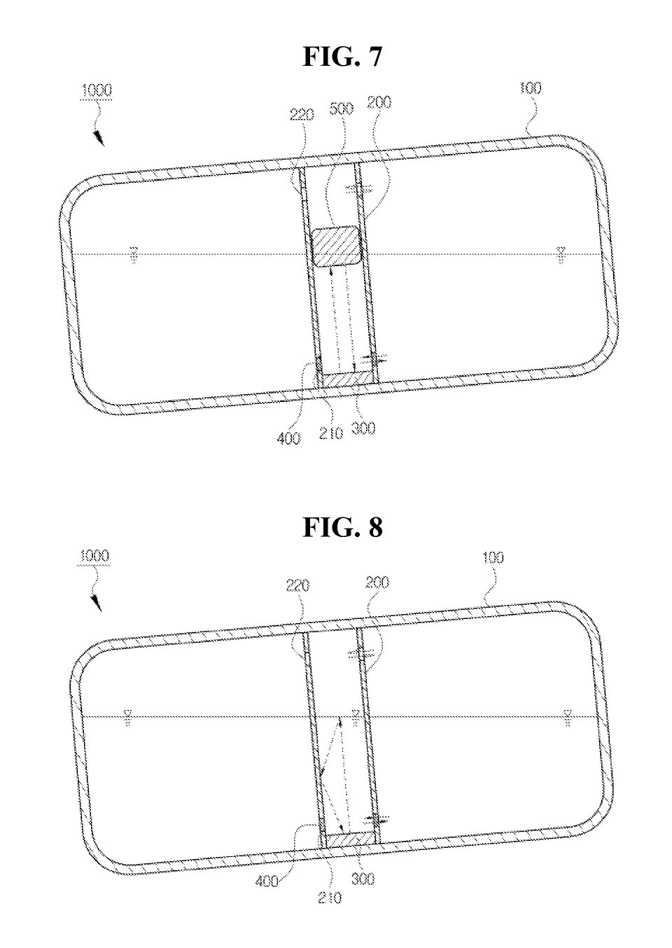

Particularly, in a case in which the vehicle is positioned on an inclined place or is moved on the inclined place, since the fuel tank 100 becomes an inclined state and the ultrasonic wave sensor 300 also becomes the inclined state, but the fuel may be kept in the horizontal state as illustrated in FIG. 7, the buoyancy body 500 may become a state inclined in the same direction together with the fuel tank 100 and the ultrasonic wave sensor 300 at the height of the surface of the fuel regardless of a gradient of the surface of the fuel. Thereby, the ultrasonic wave transmitted from the ultrasonic wave sensor 300 may be reflected from the lower surface of the buoyancy body 500 and may be incident into the ultrasonic wave sensor 300 as it is while not being bent, thereby making it possible to more accurately measure the level of the fuel.

However, as illustrated in FIG. 8, even in a case in which the buoyancy body 500 is not present in a state in which the fuel tank 100 is inclined, since the ultrasonic wave that is reflected and bent from the surface of the fuel may be reflected from the inner peripheral surface of the pipe 200 and may be incident into the ultrasonic wave sensor 300, it is possible to prevent a case in which the level is not measured and the level of the fuel may be more accurately measured as compared to a case in which the pipe 200 is not present.

In addition, the buoyancy body 500 may be formed to have a length larger than a diameter thereof.

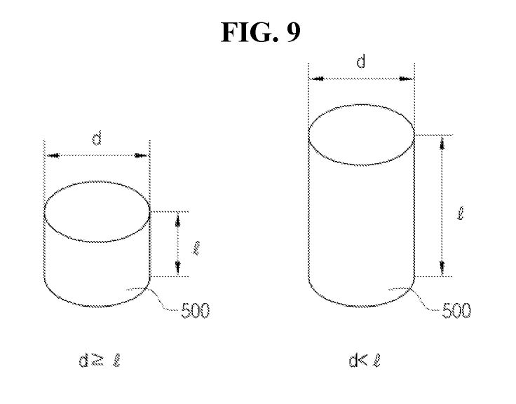

That is, since the buoyancy body 500 needs to be formed so as to be smoothly moved vertically in the pipe 200, the buoyancy body 500 is formed to have the length L larger than the diameter d, such that side pressure may not be applied to the buoyancy body 500 at the time of vertically moving the buoyancy body 500 by the flow of the fuel, as illustrated in a right side of FIG. 9. In addition, the diameter d of the buoyancy body 500 is formed to be slightly smaller than an inner diameter of the pipe 200, the buoyancy body 500 is formed of a material capable of well-reflecting the ultrasonic wave and has the lower surface formed to be flat, and corners of an upper end and a lower end of the buoyancy body 500 are subjected to a chamfering process or a rounding process so that the buoyancy body 500 may be smoothly moved in a vertical direction. In addition, frictional force of a surface of the buoyancy body 500 against a surface of the pipe 200 may be formed to be low.

In addition, the pipe 200 may be installed in the fuel tank 100 and the pipe 200 may be installed at the center of the fuel tank 100 in a horizontal direction of the fuel tank 100.

That is, as described above, in the case in which the vehicle is positioned on the inclined place or is moved on the inclined place, the fuel tank 100 becomes the inclined state. In this case, since the pipe 200 is installed in the fuel tank 100 and is installed at the center of the fuel tank 100 in the horizontal direction of the fuel tank 100, even in a case in which the fuel tank 100 is inclined, the heights of the surface of the fuel in a direction perpendicular to the bottom surface of the fuel tank 100 in the case in which the fuel tank 100 is inclined and the case in which the fuel tank 100 is horizontal may be nearly identical to each other around a central portion of the fuel tank 100.

Thereby, in a case in which the apparatus 1000 for sensing the fuel level according to the present invention is installed at the center of the fuel tank 100, even though the fuel tank 100 is inclined to some degree, it is possible to accurately measure the level of the fuel.

In addition, the ultrasonic wave sensor may also be provided to an upper end of the pipe. That is, since the ultrasonic wave is reflected from interfaces having different mediums, the ultrasonic wave sensor may also be configured to be installed at an inner upper end of the pipe to sense the level of the fuel. Also, in this case, since the shaking and the incline of the surface of the fuel in the pipe are small, it is possible to accurately measure the level of the fuel.

In addition, a hole may be formed in an upper side of the fuel tank so that the apparatus for sensing the fuel level may be inserted into the fuel tank. In addition, the pipe is formed so that the upper end thereof is closed and a flange is formed toward the outside of an outer peripheral surface of the pipe, such that the flange may be configured to be coupled to the fuel tank by a fastening means, and the ultrasonic wave sensor is installed at an upper side of a cap, which may be coupled to the lower end of the pipe. Thereby, the apparatus for sensing the fuel level is formed in a structure in which the apparatus for sensing the fuel level may be coupled to the fuel tank and an integral structure in which the upper side and the lower side thereof are sealed to include the ultrasonic wave sensor therein, such that the apparatus for sensing the fuel level is inserted into and coupled to the hole formed in the fuel tank, thereby making it possible to seal a coupling portion by a sealing member, or the like.

According to the exemplary embodiments of the present invention, in the apparatus for sensing the fuel level, since the fluid level of the fuel to be measured is not shaken, the level of the fuel may be accurately measured using the ultrasonic wave sensor.

In addition, since the foreign materials are not contained in the fuel to be measured, the level of the fuel may be more accurately sensed.

The present invention is not limited to the above-mentioned exemplary embodiments but may be variously applied, and may be variously modified by those skilled in the art to which the present invention pertains without departing from the gist of the present invention claimed in the claims.

What is claimed is:

1. An apparatus for sensing a fuel level, comprising:
a pipe vertically installed in a fuel tank and having an interior hollowed to have a fuel inflow and outflow hole formed at a lower side thereof and a gas inflow and outflow hole formed at an upper side thereof; and
an ultrasonic wave sensor provided to a lower end of the interior of the pipe to be in contact with fuel and measuring a level of the fuel by an ultrasonic wave.

2. The apparatus for sensing a fuel level of claim 1, further comprising a filter installed in the fuel inflow and outflow hole of the pipe.

3. The apparatus for sensing a fuel level of claim 2, wherein the filter is further installed in the gas inflow and outflow hole of the pipe.

4. The apparatus for sensing a fuel level of claim 1, wherein the ultrasonic wave sensor is provided to be spaced apart from an inner peripheral surface of the pipe and the fuel inflow and outflow hole is installed at a lower end portion of the pipe.

5. The apparatus for sensing a fuel level of claim 1, further comprising a buoyancy body provided in the pipe and floated by the fuel.

6. The apparatus for sensing a fuel level of claim 5, wherein the buoyancy body is formed to have a length larger than a diameter thereof.

7. The apparatus for sensing a fuel level of claim 1, wherein the pipe is installed in the fuel tank and the pipe is installed at the center of the fuel tank in a horizontal direction of the fuel tank.
